(19) United States
(12) Patent Application Publication
(10) Pub. No.: US 2013/0311216 A1
(43) Pub. Date: Nov. 21, 2013

(54) PRODUCT SUSTAINABILITY EVALUATION

(71) Applicants: Martina ROTHLEY, Schwetzingen (DE); Johann KEMMER, Muehlhausen (DE)

(72) Inventors: Martina ROTHLEY, Schwetzingen (DE); Johann KEMMER, Muehlhausen (DE)

(73) Assignee: SAP AG, Walldorf (DE)

(21) Appl. No.: 13/473,294

(22) Filed: May 16, 2012

(51) Int. Cl. G06Q 10/00

(52) U.S. Cl. 705/7.11

(57) ABSTRACT

A computer implemented method for analyzing sustainability of a product can include configuring one or more criteria relating to production and distribution of the product and weighting the criteria. At least one criteria can relate to the sustainability of the product. The method can include obtaining data relating to the production and the distribution of the product to a customer from at least one supplier. The method can include performing a green distribution analysis on the production and distribution of the product based on the weighted criteria using the obtained data.

### RELATED APPLICATIONS

The present application is related to U.S. patent application Ser. No. 13/473,247, filed on May 16, 2012, entitled “Sustainability Based Distribution Evaluation,” hereby incorporated by reference.

### BACKGROUND

To compete in today's markets companies are directing their efforts to provide products that are environmentally friendly. In addition to using materials that are recycled in the product, companies are implementing procedures that reduce waste, reduce pollution and rely on renewable energy resources. However, companies are not always able to effectively relay these efforts to their potential customers.

Some companies advertise their products as being eco-friendly because certain aspects of the product are obtained in an eco-friendly manner. However, because companies may use different criteria and may focus on different aspects of the product to justify placing an eco-friendly label on the product, customers who are interested in purchasing eco-friendly products are presented with a challenge to discern which products are more eco-friendly. For example, a supplier of a product may claim that the product is produced in a manner that is eco-friendly but fail to mention whether the transporting of the product is eco-friendly. Similarly, a supplier of a product may claim that the product is transported using renewable resources but fail to provide details as to whether the materials in the packaging or the product are eco-friendly. Such efforts to relay to the customers that the products are sustainable do not provide a customer with an overall sustainability score of the product and may provide conflicting results.

Companies interested in reducing their carbon footprint also do not have tools to effectively evaluate and compare the impact that their decisions may have on the overall sustainability of the product.

### BRIEF DESCRIPTION OF THE DRAWINGS

The accompanying drawings illustrate the present invention and, together with the description, further serve to explain the principles of the invention and to enable one skilled in the pertinent art to make and use the invention.

FIG. 1 illustrates a flow diagram of a method to perform green distribution analysis for distributing a product to a customer from a supplier, according to an exemplary embodiment.

FIG. 2 illustrates a flow diagram of a method to perform green distribution analysis for distributing a product to a customer from a supplier with options to make changes to the distribution of the product, according to an exemplary embodiment.

FIG. 3 illustrates a block diagram of a system for performing the green distribution analysis for supplying a product to a customer, according to an exemplary embodiment.

FIG. 4 illustrates a block diagram of an exemplary computer system.

### DETAILED DESCRIPTION

Various embodiments of systems and methods for evaluations of the sustainability of a product are described herein. The embodiments may include evaluating the sustainability of a product in terms of at least one of production, distribution and packaging of the product. The evaluation can be used to calculate a green distribution score based on objective criteria and results that can be communicated to prospective customers. The green distribution score can be used to improve the image of a company and to provide a competitive advantage over competitors. The evaluation can be used to provide a supply planner with fitting actions to improve the green distribution score of the product.

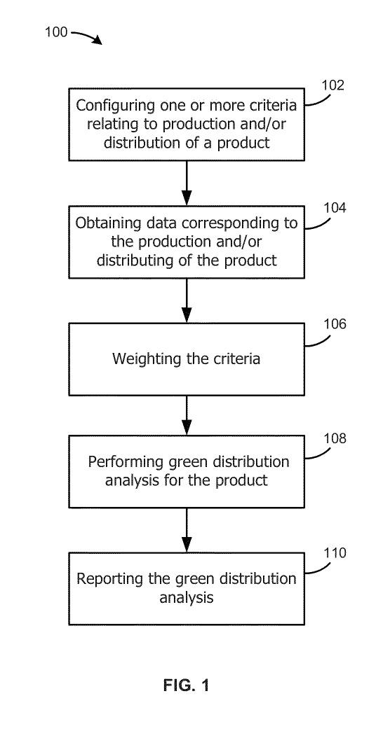

FIG. 1 illustrates a flow diagram of a method 100 to perform green distribution analysis for distributing a product to a customer from a supplier, according to an exemplary embodiment. The exemplary embodiment can include configuring one or more criteria relating to production and/or distribution of a product in step 102, obtaining data corresponding to the production and/or distributing of the product step 104, weighting the criteria in step 106, performing green distribution analysis for the product 108, and reporting the green distribution analysis in step 110. The method 100 can be implemented by a computer and may be implemented in an integrated information management system.

As used herein, the term “green” can relate to ecologically sustainable practices, measures, metrics or characteristics. As used herein, the “green distribution score” can be a numerical quantity or a combination of characters or symbols that represent the degree of the sustainability of distributing a product. The one or more criteria can be used to evaluate sustainability of a product and can include at least one of the sustainability of manufacturing the product and distributing the product. The one or more criteria may refer to material(s) used in the product, material(s) used in the manufacturing process of the product, design and functionality of the product, extraction and processing of materials, packaging, distribution, manufacturing processes, mode of transportation, mode of storing, emission control measures, distance between the supplier and a procurement site (of purchaser/customer), distance between the supplier and a storage facility, energy management measures, waste disposal measures, environmental policies, compliance certificates, low carbon emission manufacturing material, waste disposal measures, emission control measures, use of alternative fuels, recyclable packaging material, renewable energy source employed by the supplier for manufacturing, storing or transporting, and recycled or recyclable materials used in the product. The criteria may include a supplier's green distribution/manufacturing score, a product's green distribution/manufacturing score, supplier's certification relating to sustainability or a products certification relating to sustainability. The one or more criteria may be provided as one or more metrics and may include the weighting of the criteria and the interdependencies of the one or more criteria.

The terms “commodity,” “good,” and “product” can be used interchangeably and can refer to one and the same. The term “freight forwarder” can refer to a business partner in the role of a supplier, a dealer, a manufacturer, a producer, a contractor, a distributor, a retailer, or a seller dealing with the distribution of a product.

The term “customer” may refer to a purchaser or a consumer, or other entity that may purchase or request to be supplied with a product.

Obtaining data for producing a product and performing analysis on this data, may include obtaining data and performing the analysis on the supplier of the product or receiving the results of such analysis from the supplier or an organization.

In the exemplary embodiments, the integrated information management system can be an Enterprise Resource Planning (ERP) system having a plurality of business modules which are integrated to each other. The business modules can be integrated to each other over a communication network. The ERP system can be enabled with automated pull mechanisms allowing real-time processing and execution of inspection data. As used herein, the term “real-time” can refer to a time frame that is brief, appearing to be immediate or near concurrent. When the computer processes data in real time, it can read and handle data as it is received, producing results without significant delay.

In step 102, criteria relating to the production and/or the distribution of the product can be configured. The production of the product may include the manufacturing of the product or its components and the handling of the product or its components until the product is ready to be transported to a customer. The distribution of the product may include storing, packaging and transporting the product from a supplier to a customer. The criteria to be used in the analysis can be objective criteria to provide a transparent method of evaluating the production and distribution of the product.

An initial set of criteria can be defined automatically or by a user. The criteria to be used in the method can be manually selected by a user. The criteria to be used can also be automatically selected based on, for example, the type of product being distributed, acceptable practices in the industry, standards set in the industry, available information, geographical location of supplier or customer, or green industry trends. Additional criteria can be included by a user in the initial set or automatically added to the initial set after a predetermined amount of time, after an initial evaluation has been performed or after additional information is provided. The initial criteria can be set and additional criteria can be added by the seller of the product, the supplier, industry regulator or a government agency.

The criteria for the analysis can be selected to encourage sellers to be eco-friendly in the course of producing and/or distributing the product. For example, distance to a customer criterion can be included to encourage sellers to sell where the product is produced, distance to a supplier criterion can encourage the seller to purchase components for the product where the product is produced, mode of transportation criterion can encourage the seller to ship the product using modes of transportation that produce less pollution, packaging criteria can encourage the seller to use recycled packaging material or packaging that can be reused, green components criteria can encourage the seller to purchase from suppliers that provide eco-friendly components, and environments certifications criteria can encourage the company to put procedures in place that are necessary for the certifications.

In step 104, data may be obtained relating to the production and/or distribution of the product to a customer. The information may be manually entered, automatically generated based on supplied information or retrieved from databases. The data may be obtained from a database storing information relating to the product, the supplier, the distributor, the freight forwarder, the customer, web services, expert judgment using questionnaires, integrated enterprise resource planning (ERP) system(s), or any other entity associated with the distribution of the product. The information may be stored in a computer or an integrated information management system. The information may also be retrieved from one or more data source systems in communication with the computer over an integrated network. The data source systems may be maintained by the seller of the product, the supplier of the product, the distributor or any other entity associated with the distribution of the product.

The information can be entered by different individuals when they come into possession of the product. For example, a freight forwarder may enter information such as the originating location, the mode of transportation, the distance to be traveled by each mode of transportation and the type of packaging that can be used or was used during the transportation of the product, when the product is being delivered. Similarly, the supplier of the product may enter information such as how the product was manufactured, where the components of the product were obtained, the location of the product, mode of transporting the product, what kind of packaging is acceptable for the particular product or if any special handling procedures should be followed while transporting the product, when the product is produced or picked up for delivery. The information may be requested from the supplier or the freight forwarder using a questionnaire, such as an electronic questionnaire.

The information may be automatically collected by monitoring tracking devices such as GPS devices mounted on the vehicles used to transport the product, or scanning identification devices, such as bar codes or RFID tags, on the transportation means, the product or the packaging.

The data may include information for the one or more criteria that can be used to evaluate the sustainability of the product or the distribution of the product. For example, the data associated with how the product is distributed may include the location of the product, the destination of the product, the location of the customer, the location of storage facilities, the route to be taken by a distributor or freight forwarder, the mode of transportation that can be used or is used for a particular product, the times that a particular mode of transportation means is available, the amount of time it takes to travel between specified locations, distance to be traveled, materials used in the product, material used to manufacture the product, the type of packaging used for the product, the type of packaging that should be used while transporting the product, special handling instructions, cost of product from different suppliers, cost associated with the packaging, and cost for various transportation modes. The data associated with how the product is produced may include material(s) used in the product, material(s) used in the manufacturing process of the product, design and functionality of the product, extraction and processing of materials, emission control measures used in the manufacturing facilities, and waste disposal measures used at the manufacturing or storing facility.

The data may also include information relating to ecologically sustainable practices, measures, metrics or characteristics. For example, the data may include the cost associated with renewable and nonrenewable resources, the benefit factor or carbon footprint of using renewable resource or nonrenewable resource, “green” industry trends, government regulations, and incentive programs used to encourage green production or distribution practices.

In step 206, weighting of the criteria can be performed. The weighting of the criteria can include assigning a weighting factor to each of the criteria. The weighting of the one or more criteria within a system can be configured to reflect an organization's internal values, priorities, and thresholds with respect to sustainability of the production or distribution of the product. Thus, more weight can be assigned to criteria that represent valued sustainability practices. For example, criteria that are more important to achieve a reduction in the carbon footprint can be assigned a higher weighting factor and criteria that are less important can be assigned a lower weighting factor. The weighting of the criteria can also be performed on a portion of the criteria. For example, the mode of transportation and the use of recycled material in the product may only be assigned a weighting factor.

The weighting can be performed manually by a user or automatically. The weighting can be performed automatically based on the type of product being produced or delivered, acceptable practices in the industry, geographical location of supplier or customer, green industry trends, green industry standards or customer preferences. The weighting can also be adjusted in real time or periodically changed as changes occur in the world effecting the distribution of the product.

Interdependencies between the criteria may be considered when assigning the weighting to the criteria. The interdependence of the criteria may be considered because the effect that one criterion has on the sustainability may change because of the other criterion. For example, as the distance to be traveled increases the effect that the distance has on the overall sustainability of the product may increase while the type of packaging may start to play an insignificant role on the sustainability of the product. The interdependence of the criteria may be considered when assigning the weighting factor to the criteria or when analyzing the available distribution options.

Constraints can be included to consider the interdependencies of the criteria.

Examples of the one or more constraints include conditions involving interrelations such as: distance Vs mode of transport, waste disposal measures Vs zero by-product manufacturing material, waste disposal measures Vs climatic conditions, packaging material Vs mode of transport, carbon emission control Vs low carbon emission manufacturing material, source of energy Vs Geographic location, packaging Vs climatic conditions of the region. The constraints can be used to set the weighting factor to the criteria. In an example, a condition involving a distance from source to destination and mode of transport may be defined as: <<For distance>X Kms, set higher weight to the mode of transportation and lower the weight of the type of packaging>>.

In step 108 green distribution analysis may be performed on the product. The analysis can be performed based on the weighted criteria. The analysis can be performed on the criteria related to at least one of the production and distribution of the product to obtain a green distribution key performance indicator (KPI) using the one or more criteria. The analysis can include grouping the criteria into criteria that corresponds to the production of the product and into criteria that corresponds to the distribution of the product and obtaining separate scores corresponding to the sustainability of the production and the distribution of the product.

A green supplier score, which can correspond to the sustainability of a product or a supplier of the product, can be calculated separately or provided from another application. The green distribution supplier score can be calculated by, for example, using the method of green sourcing analysis disclosed in U.S. patent application Ser. No. 13/301,807 filed on Nov. 22, 2011, entitled “Sustainability Based Supplier Evaluation,” hereby incorporated by reference. The method can include configuring one or more criteria relating to a product as green sourcing metrics, defining one or more constraints effecting interdependencies between the green sourcing metrics, invoking product data relating to one or more suppliers of the product, determining that at least one of the one or more constraints is fulfilled based on the product data, customizing the green sourcing metrics based on the at least one of the one or more constraints that is fulfilled, and performing green sourcing analysis for the one or more suppliers of the product based on the customized green sourcing metrics.

To obtain a green distribution score, corresponding to at least one of the producing and distribution of the product, the criteria values can be assigned to the criteria in a manner that encourages the reduction of the carbon footprint due to production or distribution of the product. For example, a scale can be used with values that are assigned to encourage using recycled materials in the product, reducing or minimizing the transportation distance, using more eco-friendly means of transportation, and using sustainable packaging.

In step 210 the results of the green distribution analysis may be reported. The results can be reported by providing a green distribution key performance indicator (KPI) which can be calculated using the one or more criteria. The green distribution KPI may be assigned based on the values in each of the criteria for the particular distribution option. The green distribution KPI can be assigned to the product, distributor of the product, or the supplier. The green distribution KPI can be used as an indicator to customers that the product is produced and/or distributed in an eco-friendly manner thus fostering product sales.

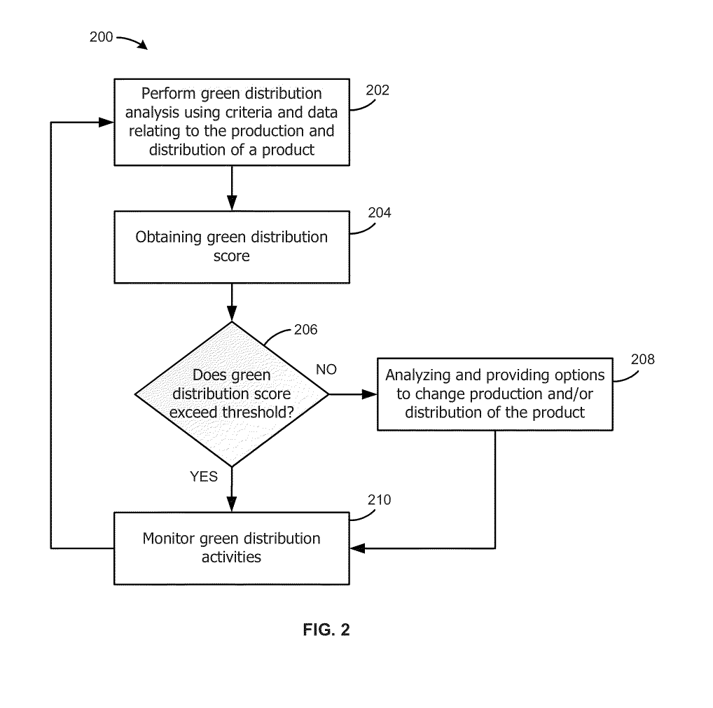

FIG. 2 illustrates a flow diagram of a method 200 to perform green distribution analysis for distributing a product to a customer from a supplier with options to make changes to the distribution of the product, according to an exemplary embodiment. The method 200 to perform green distribution analysis may include, step 202 to perform green distribution analysis using criteria and data relating to production and distribution of a product, step 204 to obtaining green distribution score, step 206 to determine whether green distribution score exceed threshold, and step 208 to analyze and provide options to change production and/or distribution of the product. Optional, step 210, can be performed to monitor the distribution activities.

In step 202, the green distribution analysis may be performed according to one or more steps discussed with reference to FIG. 1. In step 202, the green distribution analysis may include configure one or more criteria relating to production and/or distribution of a product, obtaining data relating to the production and/or the distribution of a product, and performing an analysis to obtain a green distribution score of the production and/or the distribution score of the product.

In step 206 it can be determined whether the green distribution score for the product exceeds a predetermined threshold value. The determination in step 210 may be performed on a portion of the criteria or on one of the production or the distribution of the product. The predetermined threshold value may be set based on the industry standard, level of sustainability desired by the customers, government regulations, green industry standards or value required for certification. The predetermined threshold value can be changed with changing politics or accepted standards.

If it is determined in step 206 that the green distribution score equals or exceeds a predetermined threshold value then, in step 210, an optional step of monitoring the green distribution events can be performed. However, if it is determined in step 206 that the green distribution score does not exceed the predetermined threshold value then, in step 208, an analysis can be performed on alternative options and options can be provided to change at least one of the producing and/or distribution of the product.

In step 208, the analysis can include determining the available alternative options for the production and/or the distribution of the product and performing a green distribution analysis on these options. A green distribution score may be obtained for each of the alternative options. The alternative options may be determined from the obtained data, web services, or integrated enterprise resource planning (ERP) system(s).

In step 208, the available alternative production and/or distribution options can be provided to improve the sustainability of the production and/or distribution of the product. The options can be provided to a user, such as a supply planner on seller side, responsible for making the production and/or distribution decisions. The available alternative production and/or distribution options can be provided with the green distribution KPI. The available production and/or distribution options can be provided with a ranking based on the green distribution KPI. One of the production and/or distribution options can automatically be selected, a recommendation can be made to use one or more of the distribution options, or a user can be given the option to select one of the distribution options. If an automatic decision is made, a user can confirm to make the change.

The available production and/or distribution options can be displayed based on whether the production and/or distribution options meet certain predefined conditions. For example, before a production and/or a distribution option is displayed as an available option, the production and/or distribution option may need to satisfy one or more criteria. A threshold value can be set to one or more of the criteria and the production and/or distribution can be displayed only if the values in the criteria exceed the set threshold values. The threshold value in one or more criteria can also be used to determine which of the available production and/or distribution options are green distribution options. The production and/or the distribution options that are not green can be disregarded from the analysis or from being offered as an available production and/or distribution option.

The green distribution KPI for a particular alternative production and/or distribution option may be calculated based on a score assigned to each of the criteria. For example, the mode of transportation can be classified using a standardized reference value which can be used to calculate the green transportation score for each mode of transportation, e.g., energy consumed per distance traveled and weight of the freight. Similarly, the type of packaging used can be classified by assigning the green packaging score based on the sustainability of the material used in the packaging, e.g., reusable container, recyclable materials, or recycled materials.

The production and/or distribution options can be provided to a user, such as a supply planner at seller side, to allow the user to select which of the production and/or the distribution options should be used to distribute the product. The production options may include selecting the supplier of the product. The user can be provided with a proposal based on objective criteria for a more sustainable supplier of the product, freight forwarder, means of transportation and packaging, and lower cost. The user may have the option to select a supplier, mode of transportation and packaging that cost more but does more to reduce the carbon footprint that may be left by the particular product and/or distribution option. The user may also be provided with the green distribution KPI for each option, to show the user the contribution that the particular method of distributing the product makes in reducing the carbon footprint. The user may also be provided with the total cost associated with each of the available distribution options.

Alternatively, the analysis of the alternative options, may be performed in step 204 when the initial analysis of the product is performed.

In step 210, monitoring of the green distribution activities can be performed. Green distribution activities can include the production of the product and/or distribution of the product. The monitoring can be performed to determine if the actions selected to be taken reduce the carbon footprint of the product and/or company. The monitoring can be used to provide a certification of the efforts taken by a company to reduce the carbon footprint created by the product and/or company.

The monitoring can be performed to determine if changes in the industry, politics, regulations or environment can change the results of the analysis. The analysis can be repeated if additional or updated data is received, if criteria are added or removed, if freight distributors are added or deleted, if green industry trends change, or if other changes occur effecting the production and/or distribution of the product or how sustainability is measured. The steps of the exemplary methods can be repeated to determine if any of these changes can be used to reduce the carbon footprint caused by the distribution option. The monitoring of the production and/or distribution can also be performed to determine if new options that become available in the production and/or distribution of the product can improve the green distribution score of the product.

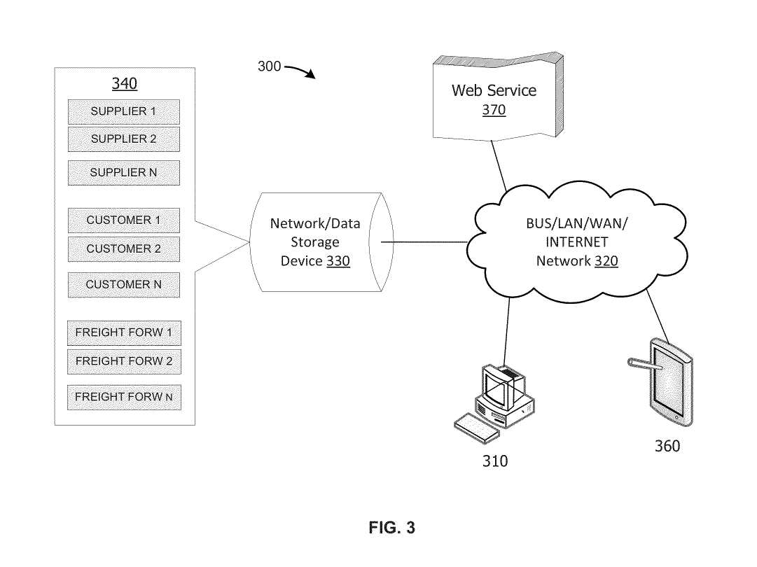

FIG. 3 illustrates a block diagram of a system 300 for performing the green distribution analysis for supplying a product to a customer, according to an exemplary embodiment. The system 300 may include computer 310, network 320, storage device 330, data source 340, control device 360 and web service 370. The computer 310, storage device 330, control device 360 and web service 370 can be coupled to each other via the network 320.

The computer 310 may control the integrated information management system which can be an ERP system having a plurality of business modules which are integrated to each other. The computer 310 may include a processing unit, a storage device and input and output devices. The computer 310 may perform the exemplary methods to analyze the production and/or the distribution options of a product from one or more suppliers using the one or more criteria and provide green distribution analysis results to a user or to make automatic selection of a an eco-friendly distribution option.

The computer 310 may be configured to find and select suppliers that can produce the product and freight forwarders that can deliver the product to a customer. The computer 310 can be configured to analyze the production and/or distribution procedures to determine the sustainability of these procedures and to determine if options are available to improve the sustainability of the product. For example, the computer 310 can provide a search functionality to find alternative supplier or freight forwarders and compare the performance based on one or more criteria of the current supplier or freight forwarder to the one or more alternative suppliers or freight forwarders.

The computer 310 may also be configured to provide a cost comparison between the current method of production and/or distributing the product and the one or more alternative production and/or distributing options. The cost comparison can be used by a user, such as a supply planner, to check the impact on the profitability that switching to a more sustainable alternative may make. The cost comparison can also be used in the negotiation with potential freight forwarders or distributors or even with eco-hearted customers to show the impact some options may have on the sustainability of the distribution.

The results of the analysis and/or available alternatives can be displayed to a user, such as a supply planner, on the computer 310 or control device 360. The results can include alternative distribution options that bundle the delivery of products and optimize the deliveries to multiple customer or from multiple distribution centers. The user can be provided with the details of the report showing the KPI scores and/or a ranked list of the available options including one or more of the suppliers, mode of transportation, the type of packaging that can be used, the distance, the cost, and the reduction of carbon footprint. The user can make a decision based on the received information. Optionally, an approval workflow can be started after the user makes a decision.

A log can be created explaining the details and results of the analysis. The log can be displayed on the computer 310 or control device 360, or stored on the computer 310 or storage device 330. The log can include information used to perform the analysis, analysis results, and weighting of the criteria.

The computer 310 may also be configured to monitor and report the carbon footprint reduction due to using the alternative production and/or distribution options. The seller's reporting can be provided to the customer, producer of the product, distributor, freight forwarder or government agency. The reporting can be used to prove eco-friendliness or provide certification that a product is environmentally friendly or that the product meets certain standards. The reporting can include providing the sustainability reports of each available distribution option.

Network 320 may include a LAN, WAN, bus, or the Internet. The storage device 330 may be used to store the data associated with the distribution of a product. The storage device 330 may be a part of the ERP system. In some embodiments the network storage device 330 may also be separate from the ERP system but connected to it through the network 320. The storage device 330 may contain a hard disk drive, flash memory, or other computer readable media capable of storing data.

The storage device 330 may be coupled to a data source 340 that can provide information regarding the production and/or distribution of the products. The data source 340 may include information relating to the supplier of the product, the freight forwarders and the customers.

The computer 310 can be configured to periodically analyze the data stored in the storage device 330 to optimize the production and/or distribution processes regarding the green features. The data that can be periodically analyzed and can include the green distribution score of the supplier, customer location, freight forwarder location, distribution and storage center locations, mode of transportation, type of packaging and other data associated with the distribution of the product.

Control device 360 may be included for a user to enter information relating to the production and/or distribution of the product or to make adjustments to the supplier of the product or the way a product is distributed. For example, a user may enter customer or freight forwarder information using control device 360. Control device 360 may also be used to display the analysis results of the delivery options and report the progress of the carbon footprint reduction. The results may also be displayed on the computer 310 or on mobile devices such as smartphones or iPads. The computer 310 or the control device 360 may be used to add new criteria, to remove criteria, or to change how the criteria are weighted.

A web service 370 may be used to find alternative suppliers of the product or freight forwarders to be analyzed and compared. The web service 370 may find the alternative suppliers or freight forwarders who are located within a predefined distance from the customer and/or the storage location. The web service 370 may also be used to provide information to be displayed on the computer 310 or the control device 360 about the supplier, freight forwarder, the mode of transportation offered, the cost associated with each mode of transportation and type of packaging, amount of carbon emission that can be produced, or terms and conditions of a contract. The web service 370 may be used to monitor and report on the current trends in the industry of the product, green industry trends, changing politics or distribution cost.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components can be tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

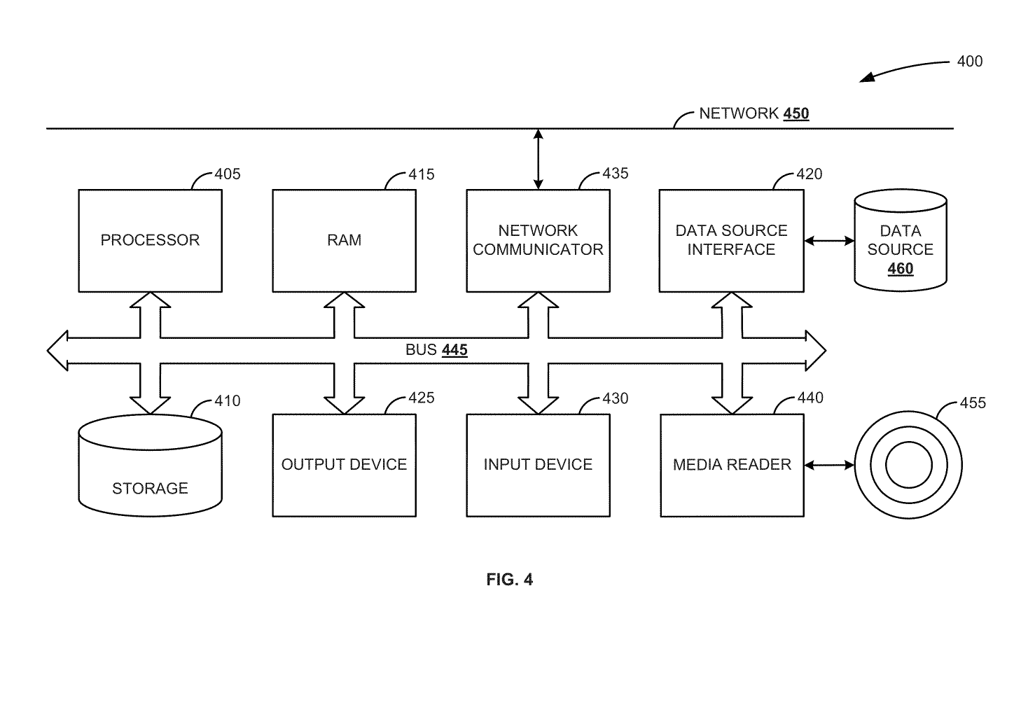

FIG. 4 illustrates a block diagram of an exemplary computer system 400. The computer system 400 can include a processor 405 that executes software instructions or code stored on a computer readable storage medium 455 to perform the above-illustrated methods of the invention. The computer system 400 can include a media reader 440 to read the instructions from the computer readable storage medium 455 and store the instructions in storage 410 or in random access memory (RAM) 415. The storage 410 provides a large space for keeping static data where at least some instructions could be stored for later execution. The stored instructions may be further compiled to generate other representations of the instructions and dynamically stored in the RAM 415. The processor 405 reads instructions from the RAM 415 and performs actions as instructed. According to one embodiment of the invention, the computer system 400 further includes an output device 425 (e.g., a display) to provide at least some of the results of the execution as output including, but not limited to, visual information to users and an input device 430 to provide a user or another device with means for entering data and/or otherwise interact with the computer system 400. Each of these output devices 425 and input devices 430 could be joined by one or more additional peripherals to further expand the capabilities of the computer system 400. A network communicator 435 may be provided to connect the computer system 400 to a network 450 and in turn to other devices connected to the network 450 including other clients, servers, data stores, and interfaces, for instance. The modules of the computer system 400 are interconnected via a bus 445. Computer system 400 includes a data source interface 420 to access data source 460. The data source 460 can be accessed via one or more abstraction layers implemented in hardware or software. For example, the data source 460 may be accessed by network 450. In some embodiments the data source 460 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

We claim:

1. A computer implemented method for analyzing sustainability of a product, comprising:
configuring one or more criteria relating to production and distribution of the product, wherein at least one criteria relates to the sustainability of the product;
obtaining data relating to the production and the distribution of the product to a customer from at least one supplier;
weighting the criteria; and
performing a green distribution analysis, by the computer, on the production and distribution of the product based on the weighted criteria using the obtained data.

2. The method of claim 1, further comprises providing, by the computer, a green distribution score for the product based on the green distribution analysis.

3. The method of claim 1, further comprises providing an option, by the computer, to change the weighting of the criteria.

4. The method of claim 1, further comprises providing an option, by the computer, to include new criteria or to remove the one or more of the configured criteria.

5. The method of claim 1, wherein the weighting of the one or more criteria is performed based on at least one of customer characteristics, industry standards, certification standards, government policies, regulation requirements, transportation modes, fuel prices, and supplier characteristics.

6. The method of claim 1, wherein the weighting of the one or more criteria is automatically changed, by the computer, based on changing political situation, customer characteristic or supplier characteristics.

7. The method of claim 1, wherein the one or more criteria relating to the distribution of the product includes a mode of transportation and a type of packaging.

8. The method of claim 1, wherein the one or more criteria relating to the production of the product includes a green distribution supplier score provided by the supplier.

9. The method of claim 1, wherein the weighting of the criteria includes weighting of the criteria based on interdependencies of the criteria.

10. A computer implemented method for analyzing sustainability of a product, comprising:
configuring one or more criteria relating to production and distribution of the product, wherein at least one criteria relates to the sustainability of the product;
obtaining data relating to the production and the distribution of the product to a customer from at least one supplier;
performing a green distribution analysis, by the computer, on the production and distribution of the product based on the criteria using the obtained data to obtain a green distribution score;
analyzing, by the computer, alternative options relating to at least one of production and distribution of the product, if the green distribution score is below a predetermined value; and
providing alternative options relating to the production of the product or the distribution of the product, if the green distribution score is below a predetermined value.

11. The method of claim 10, further comprises monitoring the production and distribution of the product to determine if new options that become available in the production or distribution of the product can improve the green distribution score of the product.

12. The method of claim 10, wherein the provided alternative options includes displaying only the alternative options that are determined to improve the green distributions score of the product.

13. The method of claim 10, further comprises weighting the criteria.

14. The method of claim 13, further comprises providing an option, by the computer, to change the weighting of the criteria.

15. The method of claim 13 wherein the weighting of the one or more criteria is performed based on at least one of customer characteristics, industry standards, certification standards, government policies, regulation requirements, transportation modes, fuel prices, and supplier characteristics.

16. The method of claim 10, further comprises providing an option, by the computer, to include new criteria or to remove the one or more configured criteria.

17. The method of claim 10, wherein the one or more criteria relating to the production of the product includes a green distribution supplier score provided by the supplier.

18. The method of claim 10, wherein the provided alternative options include options to change at least one of the supplier of the product, a transportation mode of the product, and a packaging of the product.

19. A non-transitory computer readable medium comprising a set of stored instructions that, when executed by a processing device, cause the processing device to:
configure one or more criteria relating to production and distribution of the product, wherein at least one criteria relates to the sustainability of the product;
obtain data relating to the production and the distribution of the product to a customer from at least one supplier;
weight the criteria; and
perform a green distribution analysis on the production and distribution of the product based on the weighted criteria using the obtained data.

20. A computer system for analyzing the sustainability of a product comprising:
a data storage device storing data relating to the production and the distribution of the product to a customer from at least one supplier;
a processor in communication with the data storage device, the processor being configured to:
configuring one or more criteria relating to production and distribution of the product, wherein at least one criteria relates to the sustainability of the product;
weighting the criteria; and
performing a green distribution analysis on the production and distribution of the product based on the weighted criteria using the data stored in the data storage device.
